(19) United States
(12) Patent Application Publication
(10) Pub. No.: US 2016/0145118 A1
(43) Pub. Date: May 26, 2016

(54) METHOD AND APPARATUS FOR ROASTING OF MANGANESE ORE

(71) Applicant: TRONOX, LLC, Oklahoma City, OK (US)

(72) Inventors: Harry E. Flynn, Edmond, OK (US); Ed Crowder, Edmond, OK (US)

(21) Appl. No.: 14/548,443

(22) Filed: Nov. 20, 2014

(51) Int. Cl. C01G 45/02; B01J 19/24

(52) U.S. Cl. CPC C01G 45/02; B01J 19/24; B01J 2219/24; B01J 2219/0015

(57) ABSTRACT

A system and method configured for reducing MnO₂ to MnO. The system and method provide post-combustion gases having at least 5% by volume CO to a pile of MnO₂ ore. The post-combustion gases permeate throughout and envelope the pile of MnO₂ ore thereby substantially precluding entry of atmospheric gas during the reduction of MnO₂ to MnO. As a result, the need to manipulate the pile of MnO₂ ore is substantially reduced or eliminated.

### BACKGROUND

Several processes are available for preparing electrolytic manganese and manganese dioxide. One of the most common processes for preparing electrolytic manganese and manganese dioxide utilizes a burner or manifold with manganese ore piled on the burner. To drive the reduction the burner operates under sub-stoichiometric conditions necessary to produce excess carbon monoxide. Thus, the roasting process involves the reaction: MnO₂+CO→MnO+CO₂.

Unfortunately, current burner configurations do not adequately distribute the reduction gas through and over the ore pile. As a result, the described process lacks efficiency, as the produced carbon monoxide does not readily penetrate the pile of ore. In particular, as depicted in FIGS. 7-9, current systems poorly distribute the reduction gas (CO) throughout the ore pile. Further, the current design induces or permits inflow of air into the ore pile resulting in reoxidation of the reduce ore. Thus, only that portion of the pile exposed to a consistent atmosphere of 5% CO undergoes reduction. See FIG. 9. As a result, the operator must physically turn the ore pile multiple times in order to achieve substantial reduction of manganese dioxide to manganese oxide.

The present invention provides improved burner configurations and improved methods for reducing manganese dioxide to manganese oxide.

### SUMMARY

In one embodiment the present invention provides a hearth configured to convert manganese ore to manganese oxide. The hearth comprises a slag layer, a layer of insulation, a fuel/air distributor and a fuel/air delivery system. The fuel/air distributor receives air and a combustible gas via fuel/air delivery system from a supply source (not shown) and distributes the air/fuel mixture to combustion ports. The combustion ports commonly have diameters ranging from about 0.0625 inch to about 0.75 inch and the arrangement of combustion ports differ in configuration depending on the location on the upper surface of the fuel/air distributor. The combustion ports in the outer perimeter direct exiting gases at an angle of about 30° to about 150° when measured with respect to the central region of the upper surface while the combustion ports located within the central region generally direct gases at an angle between about 80° and 100° from the upper surface. The upper surface has a greater density of combustion ports per square foot in the region of the outer perimeter than the density of the combustion ports in the central region. Typically, the number of combustion ports along the outer perimeter will range from 20 to 60 ports per square foot. Typically, the number of ports within the central region will range from about 2 to about 10 per square foot.

The present invention also provides a method for converting MnO₂ ore to MnO. According to the method disclosed herein, an ore pile is constructed on a hearth. Generally, the ore pile rests upon a slag layer. The slag layer having been prepared on the surface of an insulation layer supported by an air/fuel distributor. The ore pile has a generally pyramidal configuration with the peak corresponding to the longitudinal center line of the hearth. Conversion of ore to MnO occurs in a single step. The hearth utilized in the method of the present invention has the general configuration described in the foregoing paragraph and in more detail below. Accordingly, a combustible gas such as propane, natural gas or other fuel source is provided to a fuel/air delivery system and transported to a fuel/air distributor forming the lower portion of the hearth. The air/fuel mixture passes through the fuel/air distributor in a manner to provide for even distribution of the resulting post-combustion gases throughout and over the ore pile. The air/fuel mixture exits through combustion ports located in the upper surface of the air/fuel distributor with the combustion gas having specific imparted angular paths provided by combustion ports located in the upper surface of the air/fuel distributor. The air/fuel mixture passes through the insulation layer and the subsequent slag layer. In general, combustion of the air/fuel mixture occurs either within the slag layer or at the interface of the slag layer and ore pile. As a result of the imparted flow provided by the air/fuel distributor, the resulting post-combustion gases envelope and permeate throughout the ore pile. The combustion of the air/fuel mixture occurs under sub-stoichiometric conditions to provide post-combustion gases having at least about 5% CO by volume. The CO reduces the MnO₂ to MnO. Additionally, the resulting flow of the post-combustion gases substantially precludes inflow of atmospheric gases into the ore pile. Thus, the produced MnO does not undergo are reverse oxidation process. As a result, substantially all of the MnO₂ undergoes reduction to MnO in a single step.

### BRIEF DESCRIPTION OF THE DRAWINGS

FIG. 1 is a top view of a hearth used in one embodiment of the current invention.

FIG. 1A is an enlarged view of the area designated in FIG. 1.

FIG. 2 is a side view of the hearth of FIG. 1.

FIG. 3 is an enlargement of the area identified in FIG. 2.

FIG. 4A is a cross-section view of FIG. 1 taken along lines 4A of FIG. 1 and depicting fuel/air distributor.

FIG. 4B is a cross-section view of FIG. 1 taken along lines 4A and including a cross-section view of the insulation layer, slag layer and an ore pile configuration.

FIG. 5 is an enlarged view of the area identified in FIG. 4A.

FIG. 6 is a top perspective view of the hearth of the present invention depicting an ore pile positioned on the hearth.

FIG. 7 depicts the flow of reduction gas within an ore pile when operating under prior art conditions.

FIG. 8 depicts flow velocity of the reducing gas passing through the ore pile when operating under prior art conditions.

FIG. 9 depicts the regions where manganese ore has been reduced when operating under prior art conditions.

FIG. 10 demonstrates the improvement in hearth gas mixture mass fraction provided by use of the improved hearth.

FIG. 11 demonstrates the improved reduction gas distribution throughout the ore pile, as reflected by the gas vector velocity, when using the improved hearth.

FIG. 12 demonstrates a further improvement derived from the use of angled combustion ports along the outer perimeter of the improved hearth.

FIG. 13 demonstrates the improved distribution of reducing gas throughout the ore pile when using combustion ports along the outer perimeter angled inward towards the center of the ore pile.

FIG. 14 demonstrates the improved flow velocity and flow pattern of the reducing gas passing through the ore pile when using combustion ports along the outer perimeter angled inward towards the center of the ore pile.

FIG. 15 depicts the nearly complete reduction of ore within the pile when using combustion ports along the outer perimeter angled inward towards the center of the ore pile.

FIG. 16 depicts the improved reduction of ore within the pile when using combustion ports along the outer perimeter angled inward towards the center of the ore pile and also demonstrates the impact of flow rate of reduction gas through the pile.

### DETAILED DESCRIPTION

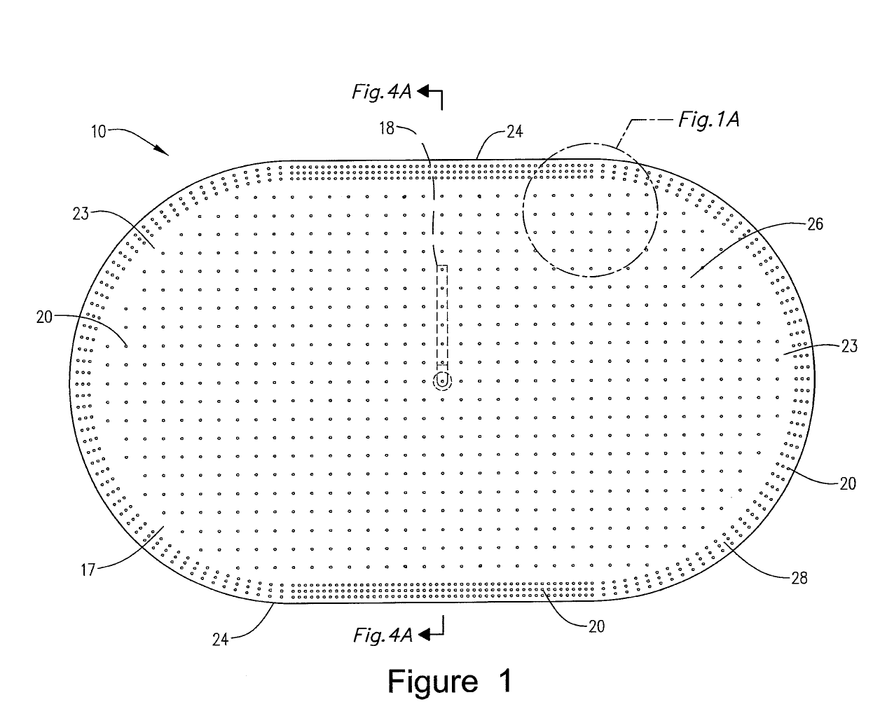

The improvements of the present invention eliminate the need to rotate or otherwise manipulate the pile of manganese order during the roasting process. FIG. 1 depicts one example of a hearth 10 configured to convert manganese ore (MnO₂) to manganese oxide (MnO). When utilized within the manufacturing process disclosed herein, hearth 10 will generally be flush with the ground level or slightly above or below ground level. Use of hearth 10 in the reduction of ore permits a single step reduction of ore to MnO and eliminates or at least substantially reduces the need to breakdown and reestablish ore pile 22 multiple times to achieve the desired reduction.

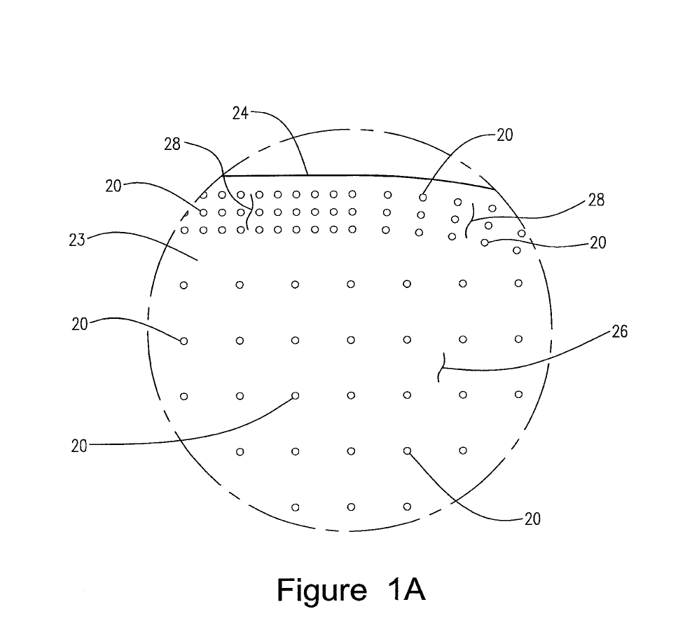

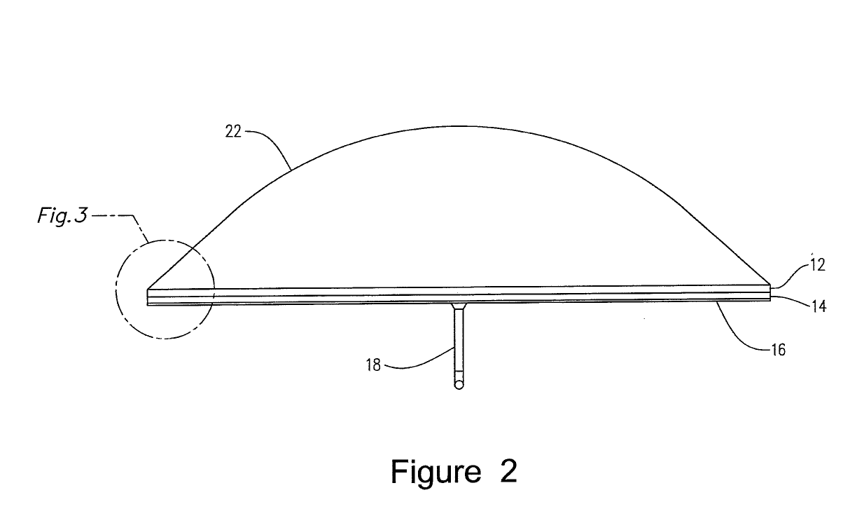

With reference to FIGS. 1-6, hearth 10 includes, from top to bottom, a slag layer 12, an optional layer of insulation 14, a fuel/air distributor 16 and a fuel/air delivery system 18. Fuel/air delivery system 18 includes valving (not shown) necessary to control the air/fuel ratio entering the fuel/air distributor 16. Suitable configurations for fuel/air distributor 16 include, but are not limited to circular, elliptical, oval or other configurations. As depicted in FIG. 1, the exemplary embodiment is in the form of an oval. Insulation layer 14 will typically range in thickness from about 3 inches to about 6 inches. Insulation layer 14 protects air/fuel distributor from the heat of combustion. Slag layer 12 will typically range in thickness from about 6 inches to about 18 inches. Ore pile 22 will typically have an overall height at the center of the pile of about 10 feet. These thickness and dimensions may vary with alternative configurations of hearth 10.

Hearth 10 is configured to support the weight of the manganese ore. In general, hearth 10 will support an ore pile 22 having a weight between about 70 tons to about 130 tons. Fuel/air distributer 16 will typically have a total cross-sectional thickness or depth of about 0.5″ to about 6″ in central region 26 and tapers to a thickness of about 0.1″ to about 4″ at outer edge 24. The transition or taper from central region 26 thickness to outer edge 24 thickness begins at the transition point 23 from central region 26 and outer perimeter 28. The transition point in thickness change is generally halfway between the center of hearth 10 and outer perimeter 28. In one embodiment, the thickness of fuel/air distributor 16 at outer edge 24 will be between about 40% and 60% of the thickness of fuel/air distributor 16 in central region 26. Typically, the thickness of fuel/air distributor 16 at outer edge 24 will be about 50% of the thickness of fuel/air distributor 16 in central region 26.

Fuel/air distributor 16 receives air and a combustible gas via fuel/air delivery system 18 from a supply source (not shown) and valve (not shown) and distributes the air/fuel mixture to combustion ports 20. Slag layer 12 cooperates with insulation layer 14 and combustion ports 20 to ensure combustion of gases such as natural gas, methane and propane under sub-stoichiometric conditions. Typically, combustion occurs at the interface between slag layer 12 and ore pile 22. Oxygen available for combustion is controlled to provide the desired post-combustion gases. For proper distribution of gases within slag layer 12 and ore pile 22, the pressure drop of pre-combustion gases through fuel/air distributor 16 should be between 0.5 and 5.0 psig. More suitably, the pressure drop across through fuel/air distributor 16 should be between 1 and 3 psig. Thus, fuel/air distributor 16, cooperates with insulation layer 14 and slag layer 12 to properly distribute combustion gases throughout and over ore pile 22. Following combustion of the air/fuel mixture, the resulting distribution of post-combustion gases encompasses ore pile 22 and permeates throughout ore pile 22 in a manner to substantially preclude penetration of air during the reduction process. Thus, fuel/air distributor 16 provides for generally uniform distribution of post-combustion gases throughout ore pile 22. As a result, the reduction reaction dominates throughout ore pile 22 and the resulting envelope of post-combustion gases containing CO substantially precludes reverse oxidation of the resulting MnO.

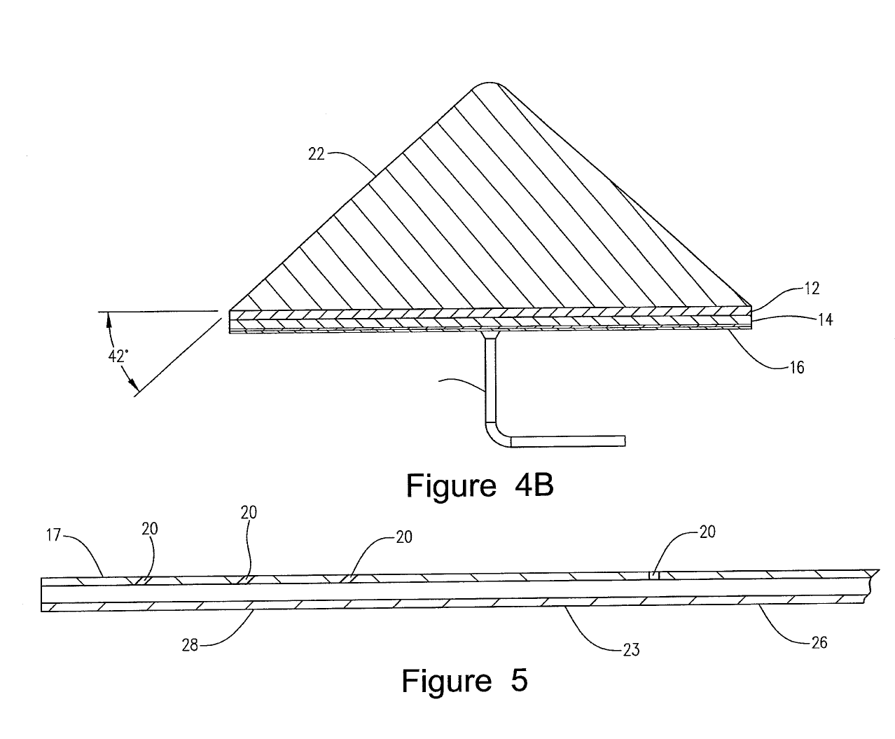

As shown in FIGS. 1, 1A, and 5, upper surface 17 of fuel/air distributor 16 has a plurality of combustion ports 20. Combustion ports 20 commonly have diameters ranging from about 0.0625 inch to about 0.75 inch. Combustion ports 20 differ in configuration depending on the location of ports 20 on upper surface 17 of fuel/air distributor 16. Combustion ports 20 positioned along the outer perimeter 28 of upper surface 17 have diameters between about 0.0625 inch and about 0.75 inch. As used herein, the term outer perimeter 28 identifies a distance between about 3 inches to 24 inches from outer edge 24. More typically, outer perimeter 28 will be a distance between about 6 inches to about 12 inches from outer edge 24. In general, outer perimeter 28 will be a distance between about 8 inches to about 10 inches.

As depicted in FIG. 5, combustion ports 20 in outer perimeter 28 direct exiting gases at an angle of about 30° to about 150° when measured with respect to the central region 26 of upper surface 17. More typically, combustion ports 20 within outer perimeter 28 will direct exiting gases at an angle of about 30° to about 60° when measured with respect to the central region 26. Thus, the 30° to 60° angle directs the combustion gases towards the center of ore pile 22. Preferably, the angle of combustion ports 20 in outer perimeter 28 corresponds generally to the slope of ore pile 22. However, the angle of combustion ports 20 may differ from the slope of ore pile 22 by +/−5 degrees. Further, as depicted in FIGS. 1 and 1A, upper surface 17 has a greater density of combustion ports 20 per square foot in the region of outer perimeter 28 than the density of combustion ports 20 in central region 26. Typically, the number of combustion ports 20 along outer perimeter 28 will range from 20 to 60 ports per square foot. More typically, outer perimeter 28 will have from about 30 to about 50 ports per square foot. Even more preferably, outer perimeter 28 will have from about 40 to about 45 ports per square foot configured in an arrangement of 2 to 5 rows encircling central region 26.

As depicted in FIG. 5, combustion ports 20 located within central region 26 generally direct gases at an angle between about 80° and 100° from upper surface 17. More typically, combustion ports 20 within central region direct gases at a 90° angle from upper surface 17. With reference to FIGS. 1 and 1A, the typical number of ports within central region 26 will range from about 2 to about 10 per square foot. More preferably, the number of ports within central region 26 will range from about 3 to about 8 per square foot. Further, to simplify manufacturing, combustion ports 20 within central region 26 will generally be arranged in a series of linear rows crossing upper surface 17. Typically, each combustion port 20 within central region 26 will be spaced about 6 to about 18 inches from adjacent combustion ports 20. However, other arrangements of combustion ports 20 within central region 26 will also provide the necessary concentration of gas for sub-stoichiometric combustion to occur. In one embodiment, the combination of fuel/air distributor 16 and all combustion ports 20 produce a flame velocity through slag layer 12 and within ore pile 22 of about 1.5 ft/sec to about 8 ft/sec. More preferably, the flame velocity will be between about 3 ft/sec to about 5 ft/sec.

Additionally, in order to enhance the reduction of manganese dioxide within ore pile 22, the configuration of fuel/air distributor 16 and the arrangement of combustion ports 20 on upper surface 17 of fuel/air distributor 16 provides for substantially homogeneous distribution of post-combustion gases throughout ore pile 22 and an envelope of post-combustion gases over ore pile 22. Thus, the post-combustion gases substantially preclude the entry of air into ore pile 22 during the reduction process. Typically, temperatures within ore pile 22 may range from about 1300° F. to about 2000° F.

Preferably, the configuration of the fuel/air distributor 16, combustion ports 20, slag layer 12 and ore pile 22 cooperate such that the sub-stoichiometric combustion of the distributed air/fuel mixture yields post-combustion gases containing at least a 5% concentration of carbon monoxide distributed substantially evenly throughout ore pile 22. More preferably, the combustion process using the configuration of the fuel/air distributor 16, combustion ports 20, slag layer 12 and ore pile 22 provides at least 100 moles of carbon monoxide per mole of manganese dioxide within ore pile 22. Further, the configuration of combustion ports 20 and air/fuel mixture gas flow velocity evenly distributes the post-combustion gases throughout the ore pile 22 thereby providing a protective layer of post-combustion gases containing carbon monoxide over ore pile 22. As a result, when operated as described herein, the configuration substantially precludes the inflow of oxidizing gas into ore pile 22. Although other angular arrangements of combustion ports 20 provide significant improvement over the prior art, more effective angles of combustion ports correspond generally to the slope of ore pile 22.

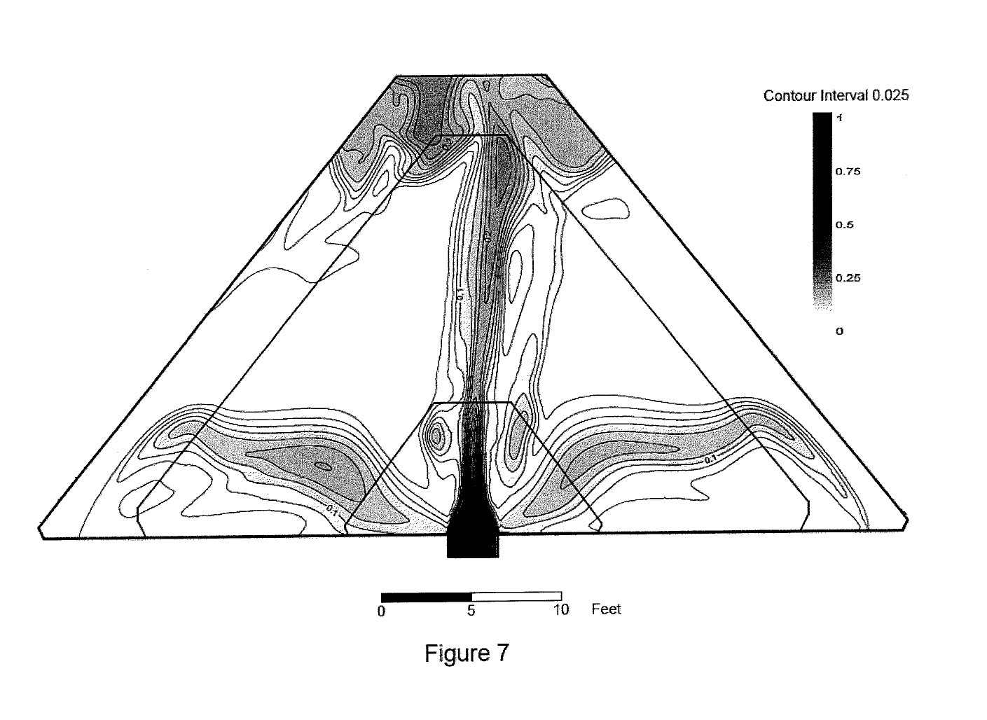

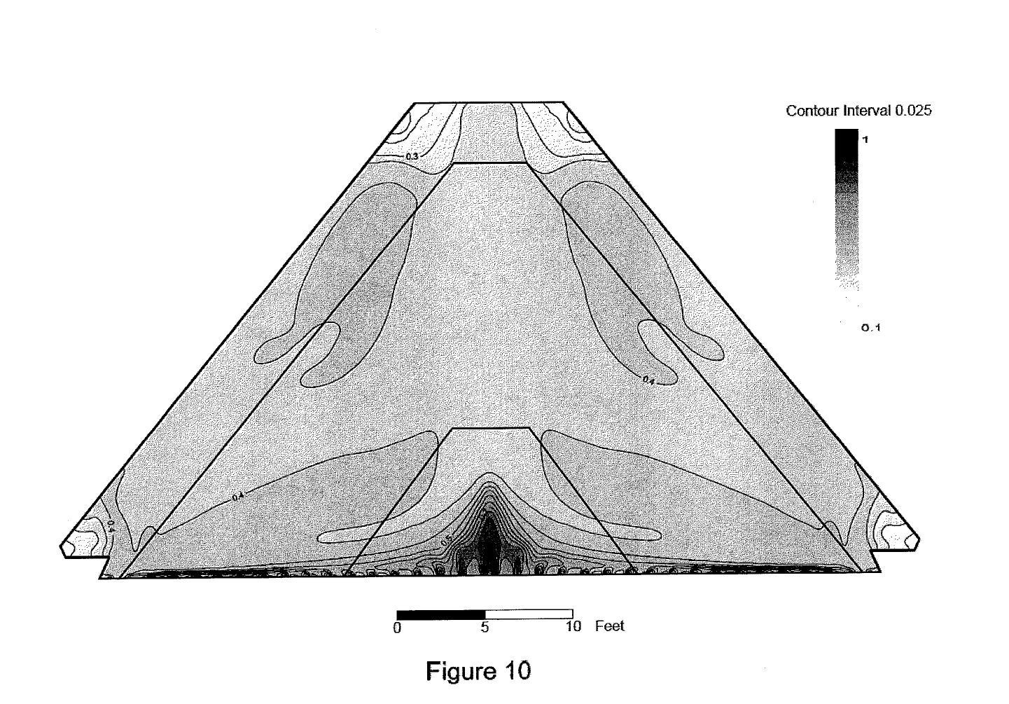

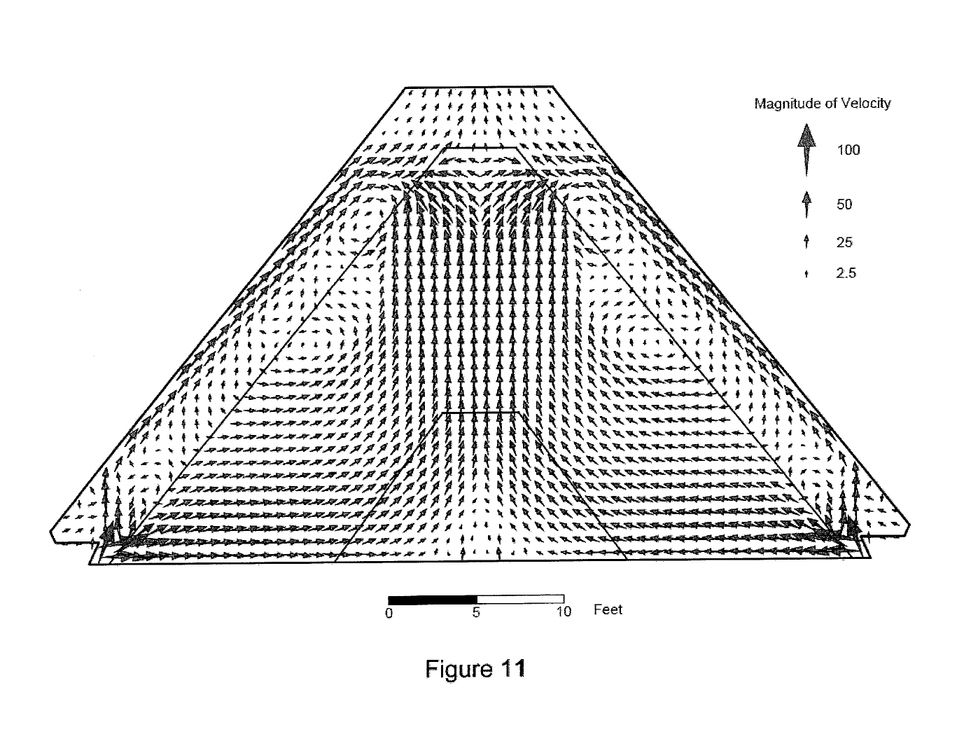

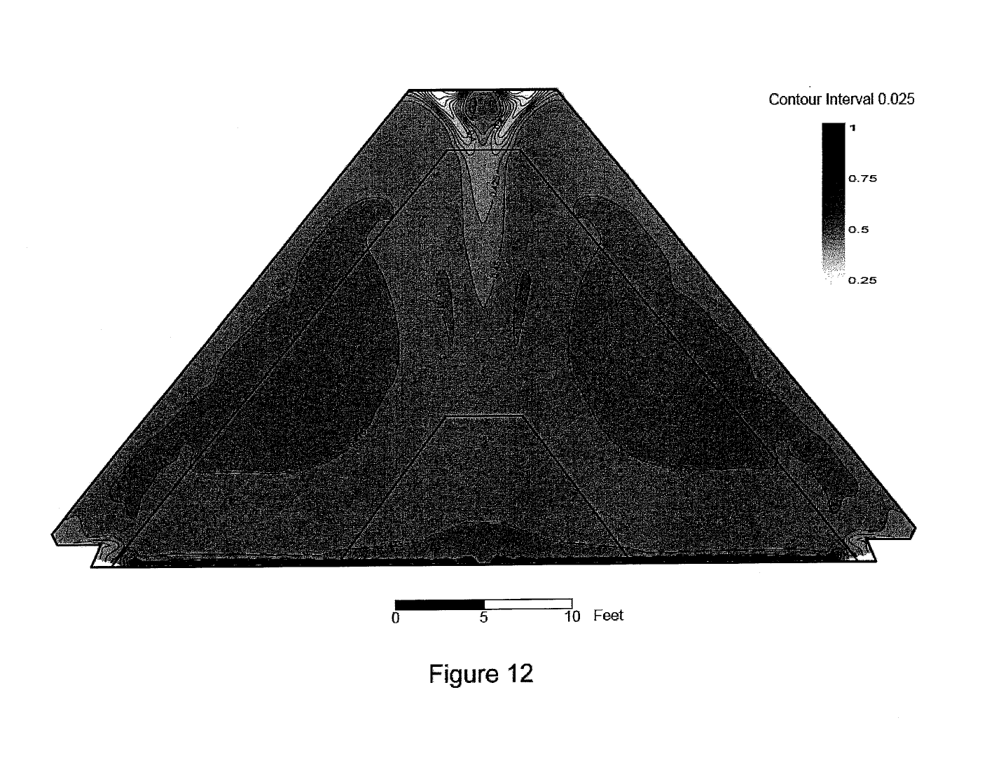

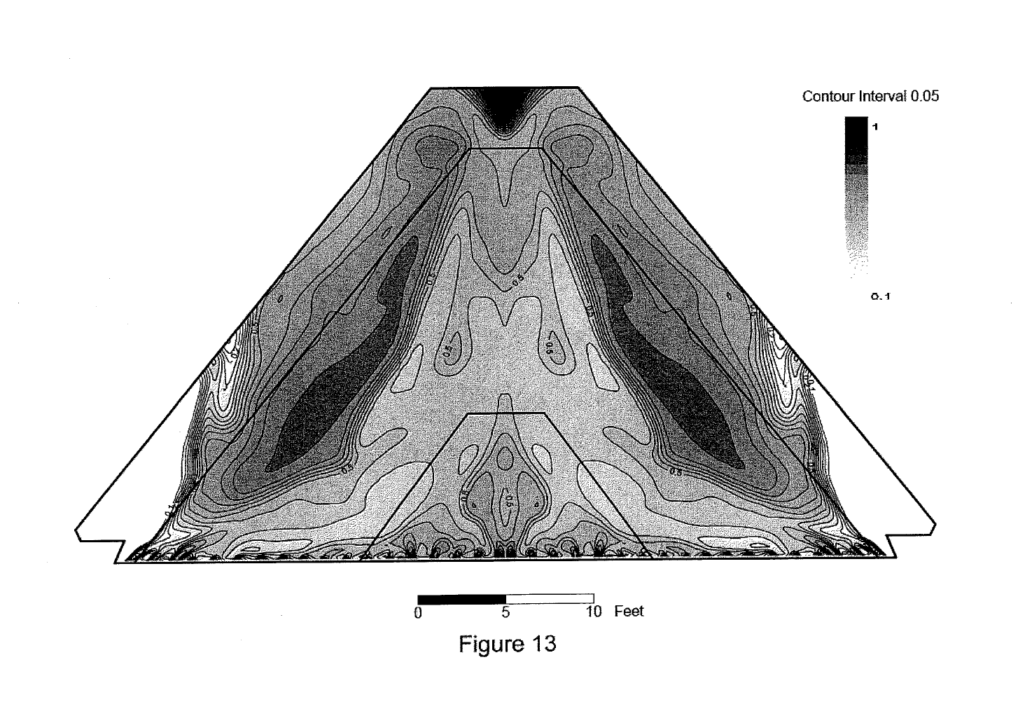

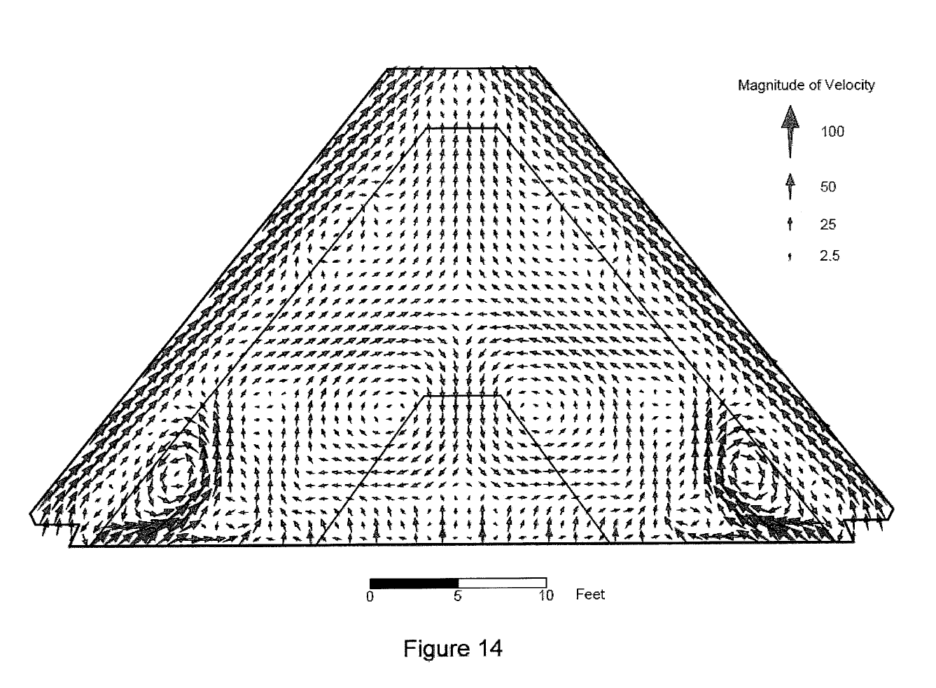

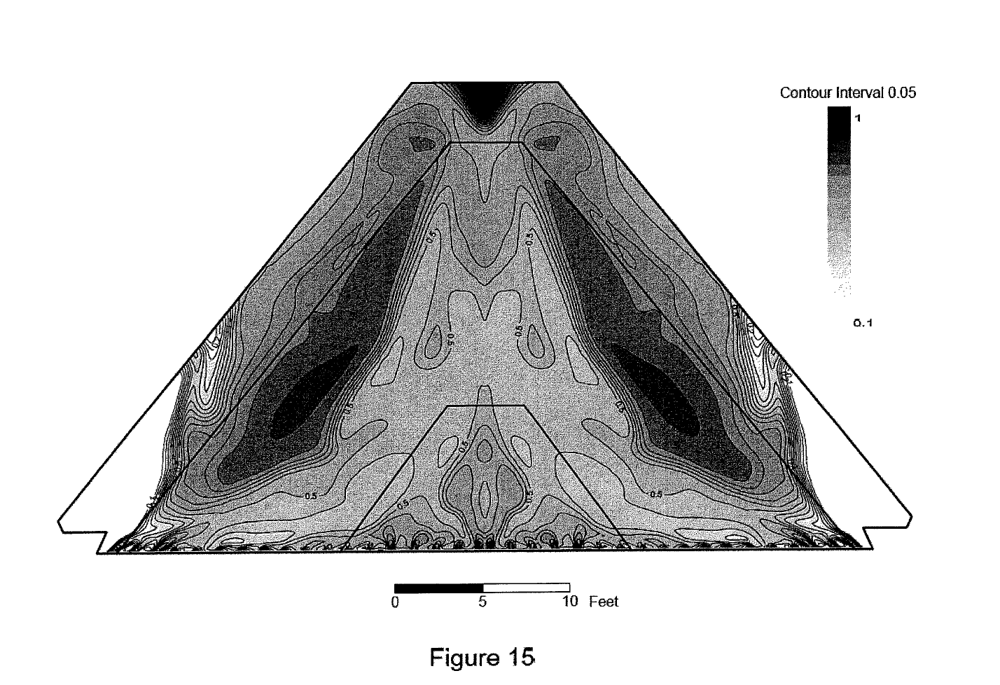

Compare, for example, FIGS. 10-12 to FIGS. 13-14 and FIG. 7. As shown by the mass fraction distributions, FIGS. 10 and 12 provide improvement over the prior art flow conditions of FIG. 7. FIG. 13 depicts even further improvement over the mass distributions of FIGS. 10 and 12. FIGS. 13 and 14 reflect the gas mix fraction and gas flow pattern and velocity vectors when using a hearth having combustion ports 20 in outer perimeter 28 angled inward at 48°, i.e. generally corresponding to the slope of the pile. As reflected by FIGS. 13 and 14, the configuration of ports 20 in outer perimeter 28 corresponding generally to the slope of ore pile 22 substantially precluded induction of air into the ore pile. Thereby providing the nearly complete reduction of the ore as reflected by FIG. 15.

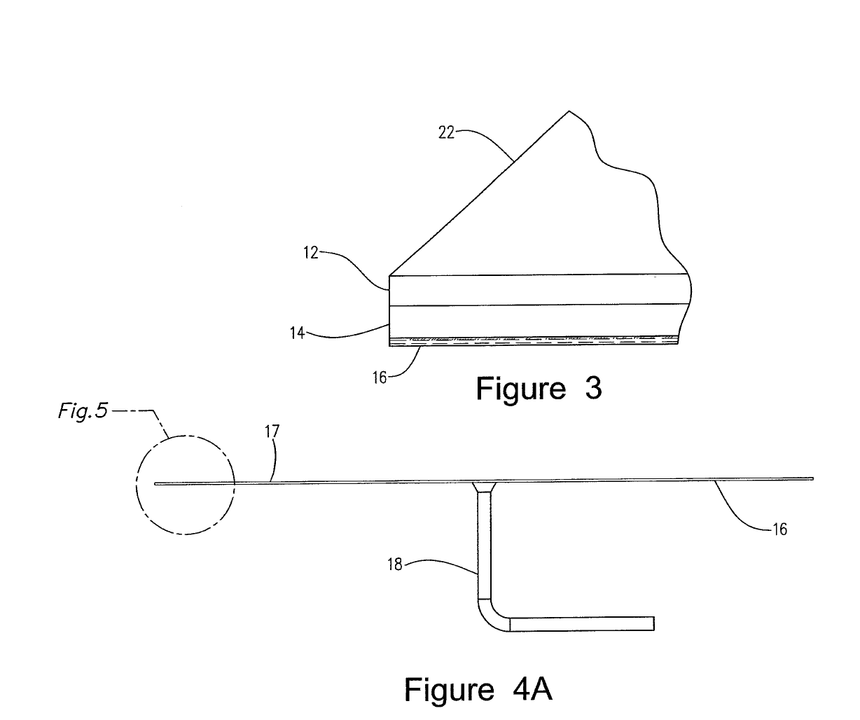

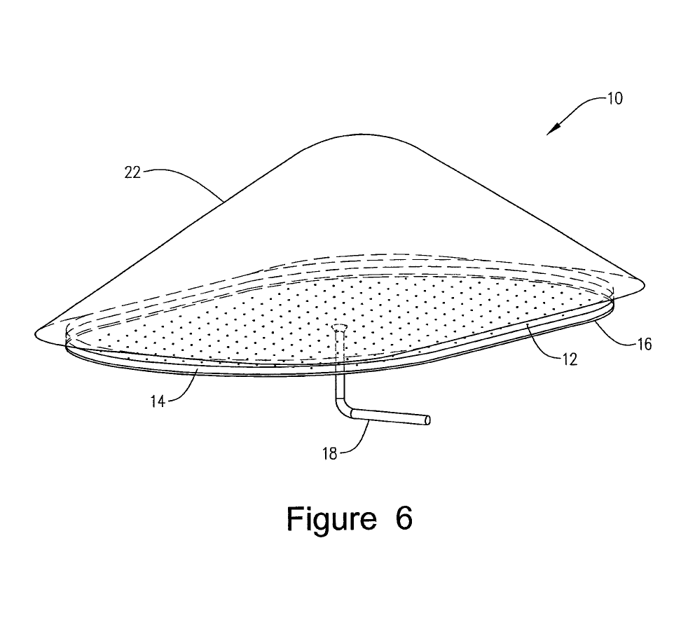

As noted above, hearth 10 supports ore pile 22. FIGS. 4B and 6 show one suitable arrangement of ore pile 22. Typically, ore pile 22 will have a porosity of about 30% to 35%; however, porosity may vary with the particle size and shape of the ore. As depicted in FIG. 4 ore pile 22 has a generally pyramidal configuration covering substantially all combustion ports 20 but not extending beyond outer edge 24. Thus, ore pile 22 will cover the outer row of combustion ports 20 but should not extend beyond the outer row by more than 12 inches. Additionally, the depth of ore pile 22 at the transition from outer perimeter 28 to central region 26 will be from about 1.7 inches to about 16 inches. More typically, the depth of ore pile 22 at the transition from outer perimeter 28 to central region 26 will be from about 3 inches to about 15 inches. Preferably, the depth of ore pile 22 at the transition from outer perimeter 28 to central region 26 will be from about 10 inches to about 14 inches.

Finally, in addition to the referenced angular alignment of combustion ports 20 in outer perimeter 28 and central region 26, the present method calls for management of the flow rate of post-combustion gases to preclude induction of atmospheric oxidizing gases into ore pile 22. Thus, a desired range of operating conditions will provide the most efficient operation of hearth 10. To determine the desired flow rate of post-combustion gases, hearth 10 should be operated to provide a Flynn modulus value between about 0 and about 0.09 during operation of hearth 10. The Flynn modulus is a dimensionless number reflecting the ability of hearth 10 to preclude entry of air into ore pile 22. The Flynn modulus value reflects the formation of a blanket or envelope of post-combustion gases containing carbon monoxide essential to precluding or at least substantially precluding entry of air into ore pile 22. The Flynn modulus value can be determined using the following formula:

Fmod=Vratio*cos(θ)*(d/D)

Where:
Fmod=Flynn modulus (dimensionless), Range 0-0.09
V ratio=ratio of mass flow of gas through combustion ports 20 in outer perimeter 28/combustion ports 20 in central region 26,
d=combustion port 20 diameter, inches
cos(θ)=jet angle from horizontal plane
D=maximum depth of ore pile 22 in central region 26, inches

The formation of the desired carbon monoxide blanket when using the foregoing described hearth 10 is demonstrated by FIGS. 13-15. As discussed above, the management of the flow rate of post-combustion gases and combustion ports 20 in outer perimeter 28 having an angle that generally corresponds to the slope of ore pile 22 provides for substantially complete reduction of the ore.

Additionally, the current invention provides a method for converting manganese ore to manganese oxide suitable for subsequent processing into electrolytic manganese and refined manganese dioxide.

The method of the present invention reduces production costs and waste. In particular, the method of the present invention eliminates the need to turn an ore pile several times to ensure complete reduction of the ore to MnO.

With continued reference to the drawings, the method of the present invention forms ore pile 22 on hearth 10. As depicted in FIGS. 4B and 6, ore pile 22 has a generally elongated pyramidal configuration. Ore pile 22 is position on hearth 10 such that the peak of ore pile 22 generally corresponds to and runs along the longitudinal centerline of hearth 10. The dimensions, including thickness of ore pile 22 are described above. However, the dimensions will necessarily be adjusted depending on the actual dimensions of hearth 10. Ore pile 22 should have a porosity of about 30% to about 35%.

Following construction of ore pile 22, the air/fuel mixture flows from fuel/air delivery system 18 into fuel/air distributor 16 passing through and exiting from combustion ports 20. Slag layer 12 aids in evenly distributing the blended air/fuel mixture to ore pile 22. Insulation layer 14 protects fuel/air distributor 16 from heat generated by the combustion of gasses. Insulation layer 14 may be formed from refractory bricks and/or other insulative material capable of passing the air/fuel mixture to the slag layer 12/ore pile 22 interface. Thus, insulation layer 14 is generally porous to the air/fuel mixture exiting from combustion ports 20. Ignition of the air/fuel mixture at the interface of slag layer 12 and ore pile 22 occurs under sub-stoichiometric conditions in order to produce post-combustion gases containing at least 5% by volume carbon monoxide. While combustion of the air/fuel mixture has been described as occurring at the slag layer 12/ore pile 22 interface, combustion within slag layer 12 will also provide satisfactory results.

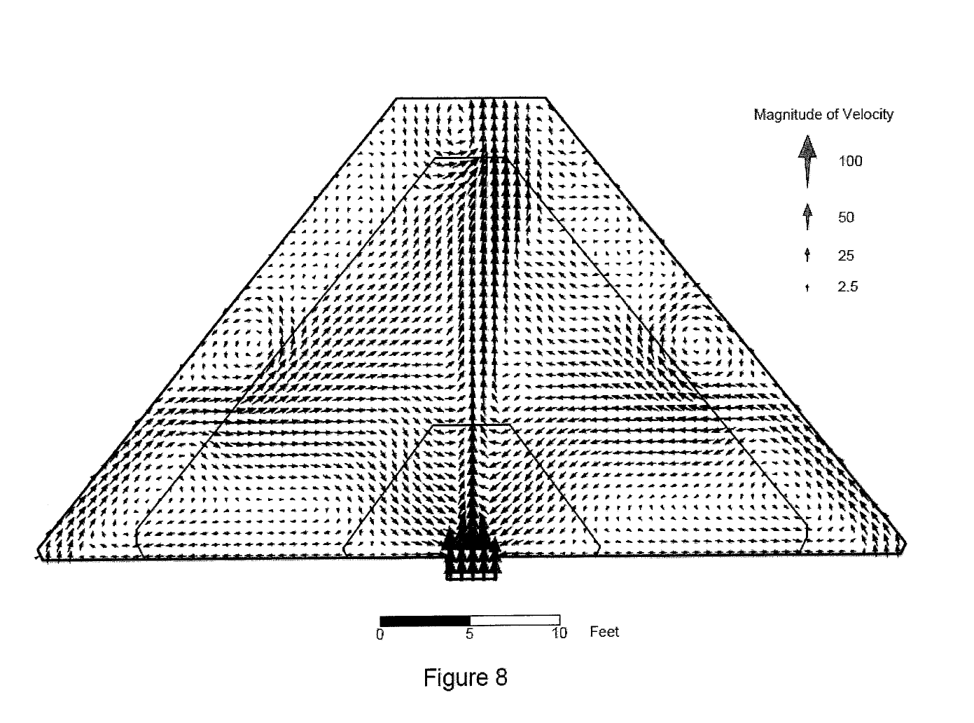

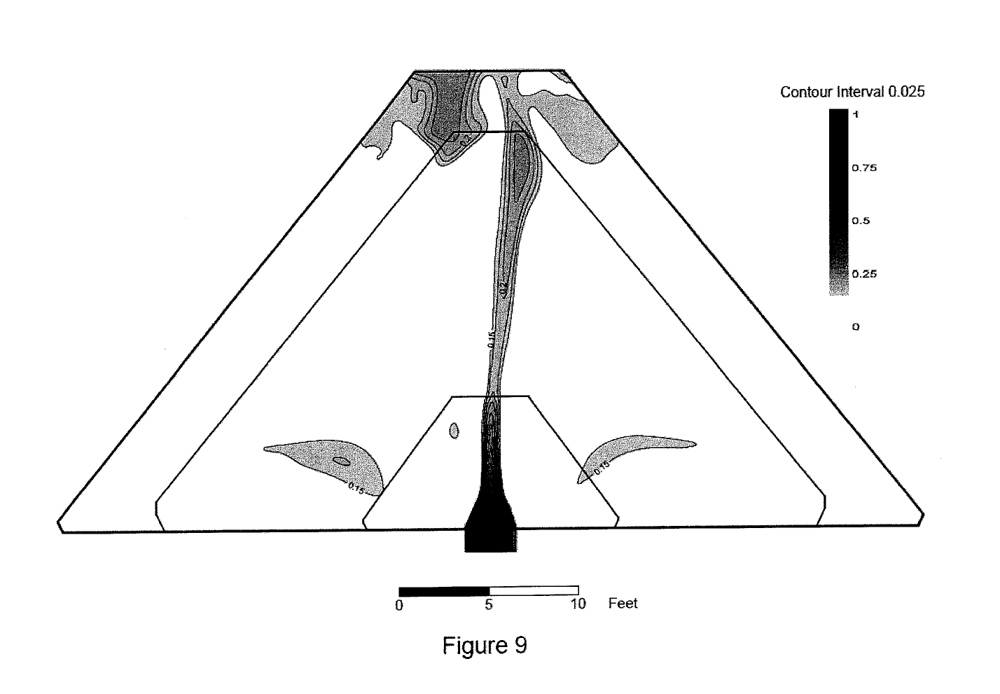

As discussed above, blanketing of ore pile 22 with a post-combustion gas atmosphere having at least 5% carbon monoxide drives the reduction reaction necessary to convert MnO₂ ore to MnO. However, maintaining the ore in the reduced state further requires precluding the inflow of air into ore pile 22. Thus, the method of the present invention further provides for maintaining the gas velocity of the air/fuel mixture and the resulting combustion gases. A comparison of FIG. 8 to FIGS. 11 and 14 reflects the improvement in gas flow pattern and velocity throughout pile 22 provided by the improved hearth. By way of a non-limiting example, for a fuel/air distributor 16 having dimensions of 6′ by 14′, the air/fuel mixture enters the fuel/air distributor 16 at a pressure of about 1 to 3 psig thereby providing a flow rate through fuel/air distributor 16 of about 200 SCFM to 450 SCFM. As a result, the post-combustion gases will pass through ore pile in a controlled manner. The combustion process occurs under sub-stoichiometric conditions to ensure the production of carbon monoxide, thereby yielding post-combustion gases suitable for reducing MnO₂ to MnO. The hot reducing post-combustion gases react with the manganese ore to convert MnO₂ to MnO according to the equation: MnO₂+CO=>MnO+CO₂. Following the reduction reaction, the resulting CO₂ and other process gases rise through the pile and are vented to a gas cleaning system (not shown). The reaction continues until all or at least substantially all of the ore is converted to MnO.

With reference to FIG. 14, operation under the described conditions will have a Flynn Modulus between 0.0 and 0.9. As reflected in this example, the Flynn Modulus is 0.015. Thus, the combustion gases will produce the depicted flow pattern within ore pile 22. As shown in FIG. 13, the resulting flow pattern also provides a blanket of combustion gases having at least 5% CO by volume over substantially all of pile 22. Similarly, FIG. 15 shows substantially complete reduction of the ore.

In general, one skilled in the art will be able to calculate the time necessary for complete reduction of the mass of ore in ore pile 22 based on the mass balance of post-combustion gases containing at least 5% CO by volume through ore pile 22. For a 60 ton pile, the reduction will be complete in 4-8 days, depending on gas flow rate.

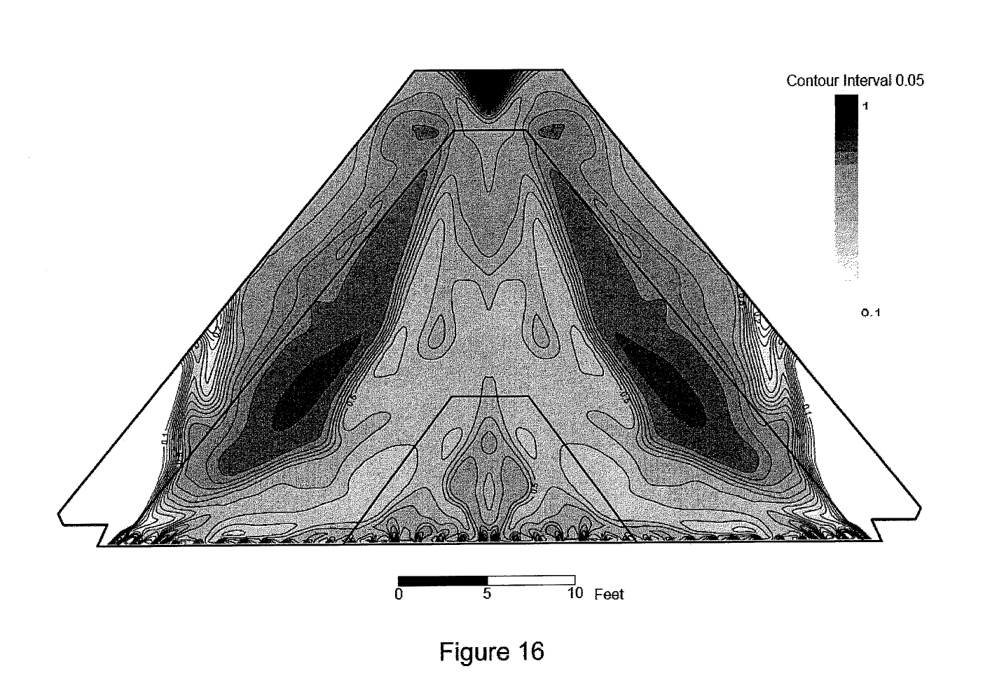

To demonstrate the advantage of operating the improved hearth 10 within the desired Flynn's Modulus range, FIG. 16 represents operation of hearth 10 under conditions that produced a Flynn's Modulus of 0.18. As reflected in FIG. 16, the excessive combustion gas velocity produced inflow of oxidizing gas into ore pile 22. Although the operation of hearth 10 under these conditions provides a marked improvement over the prior art, maintaining operating conditions that produce the desired Flynn Modulus will yield nearly complete or complete reduction of the ore to MnO.

Other embodiments of the present invention will be apparent to one skilled in the art. As such, the foregoing description merely enables and describes the general uses and methods of the present invention. Accordingly, the following claims define the true scope of the present invention.

What is claimed is:

1. A system comprising:
a fuel/air distributor in fluid communication with a fuel/air delivery system, said fuel/air distributor having an upper surface, an outer perimeter and a central region encompassed by said outer perimeter;
combustion ports providing fluid communication from an interior of said fuel/air distributor through said upper surface to the exterior of said fuel/air distributor, wherein the number of combustion ports per square foot is greater in said outer perimeter than within said central region;
an ore pile carried by said fuel/air distributor;
a slag layer positioned between said upper surface and said ore pile.

2. The system of claim 1, further comprising an insulation layer wherein said insulation layer is supported by said upper surface and said slag layer is positioned between said insulation layer and said ore pile.

3. The system of claim 1, wherein said combustion ports within said outer perimeter direct gases exiting from said ports at an angle between about 30° and about 150° when measured with respect to the central region of the upper surface.

4. The system of claim 1, wherein said combustion ports within said central region direct gases exiting from said ports at an angle between about 80° and about 100° when measured with respect to the upper surface.

5. The system of claim 1, wherein the diameter of said combustion ports may range from about 0.0625 inch to about 0.75 inch.

6. The system of claim 1, wherein said combustion ports in said outer perimeter are configured to direct exiting gases at an of about 30° to about 150° when measured with respect to the central region of the upper surface.

7. The system of claim 1, wherein said combustion ports in said central region are configured to direct exiting gases at an of about 80° to about 100° when measured with respect to the upper surface.

8. The system of claim 1, wherein said outer perimeter has from about 20 to about 60 combustion ports per square foot.

9. The system of claim 1, wherein said central region has from about 2 to about 10 combustion ports per square foot.

10. A method for converting MnO₂ to MnO comprising:
positioning a pile of MnO₂ on a hearth, said hearth comprising:
said fuel/air distributor in fluid communication with a fuel/air delivery system, said fuel/air distributor having an upper surface, an outer perimeter and a central region encompassed by said outer perimeter;
combustion ports providing fluid communication from an interior of said fuel/air distributor through said upper surface to the exterior of said fuel/air distributor, wherein the number of combustion ports per square foot is greater in said outer perimeter than within said central region; and,
a slag layer positioned between said pile of MnO₂ and said upper surface of a fuel/air distributor;
passing an air/fuel mixture through said fuel/air delivery system to said fuel/air distributor;
passing said air/fuel mixture through said combustion ports;
combusting said air/fuel mixture to generate post-combustion gases;
directing said post-combustion gases through and over said pile of MnO₂;
maintaining delivery of said air/fuel mixture for a period time and at a flow rate such that the resulting post-combustion gases substantially preclude entry of atmospheric oxidizing gases into said pile of MnO₂;
thereby reducing said MnO₂ to MnO.

11. The method of claim 10, wherein said step of combusting said air/fuel mixture initiates combustion within said slag layer.

12. The method of claim 10, wherein said step of combusting said air/fuel mixture initiates combustion at the interface between said slag layer and said pile of MnO₂.

13. The method of claim 10, wherein passage of said air/fuel mixture through said fuel/air distributor produces a pressure drop between about 0.5 and 5.0 psig upon said air/fuel mixture exiting said fuel/air distributor.

14. The method of claim 10, wherein combustion of said air/fuel mixture generates post-combustion gases containing at least 5% by volume carbon monoxide.

15. The method of claim 10, wherein combustion of said air/fuel mixture produces a flame velocity through said slag layer and within said pile of MnO₂ of 1.5 ft/sec to about 8 ft/sec.

16. The method of claim 10, wherein combustion of said air/fuel mixture produces a flame velocity through said slag layer and within said pile of MnO₂ of 3 ft/sec to about 5 ft/sec.

17. The method of claim 10, wherein combustion of said air/fuel mixture provides a substantially consistent temperature throughout said pile of MnO₂.

18. The method of claim 17, wherein the temperature of said pile of MnO₂ may range from about 1300° F. to about 2000° F.

19. The method of claim 10, wherein the flow rate of post-combustion gases has a Flynn modulus between about 0 and 0.09 as calculated by Fmod=Vratio*cos(θ)*(d/D)
where:
Fmod=Flynn modulus (dimensionless)
V ratio=ratio of mass flow of gas through combustion ports in outer perimeter/mass flow of gas through combustion ports in central region,
d=combustion port diameter in inches
cos(θ)=jet angle of gases exiting combustion ports determined with reference to the horizontal plane
D=maximum depth of ore pile in central region in inches.

20. The method of claim 10, wherein said air/fuel mixture enters said fuel/air distributor at a pressure of about 1 to about 3 psig and has a flow rate of about 200 SCFM to about 450 SCFM through said fuel/air distributor.

21. The method of claim 10, wherein combusting said air/fuel mixture yields at least 100 moles of carbon monoxide for every mole of MnO₂.

22. The method of claim 10, wherein said pile of MnO₂ is from about 25 to 50 tons and the period of time of delivering said air/fuel mixture is from about 40 to about 166 hours, thereby reducing said MnO₂ to MnO in a single step.

23. The method of claim 10, wherein the reduction of MnO₂ to MnO requires no more than three mechanical manipulations of said pile of MnO₂.
